(19) United States
(12) Patent Application Publication
(10) Pub. No.: US 2011/0030522 A1
(43) Pub. Date: Feb. 10, 2011

(54) FOOD SLICING DEVICE

(76) Inventor: Gert Wilem Barnes, Corby Northamptonshire (GB)

Correspondence Address: LOUIS VENTRE, JR, 2483 OAKTON HILLS DRIVE, OAKTON, VA, 22124-1530, US

(21) Appl. No.: 12/935,949

(22) PCT Filed: Mar. 26, 2009
(86) PCT No.: PCT/GB09/50291

§ 371 Date: Oct. 1, 2010

(30) Foreign Application Priority Data
Apr. 2, 2008 (CN) 200810035528.7

(51) Int. Cl. B26D 7/06

(52) U.S. Cl. 83/409

(57) ABSTRACT

A food slicing device is disclosed for slicing potatoes, apples, cucumbers and the like. The device comprise holding means for holding the food to be sliced and conveyance means for conveying the food to be sliced in a conveyance direction along the device and for simultaneously rotating the means for holding the food substantially about an axis comprising the conveyance direction. The device further comprises a cutter positioned substantially within the conveyance direction and is arranged to cut the food at one side of the axis of rotation as the food is conveyed along the conveyance direction and rotates about an axis comprising the conveyance direction, to produce a substantially helical food shape.

The present invention relates to a food slicing device and particularly, but not exclusively, to a food slicing device used in the slicing of potatoes, cucumbers, apples and the like.

Chinese patent number CN2478713 discloses a rotary slicer, comprising a manually operated rotary traveling mechanism. A cutter is provided at front of the machine and a push pedal is equipped on the horizontal plane and can be pushed by a push handle toward the cutter. A fixed disk with a crank handle is provided on the push pedal and is used to fix the food to be sliced. During use, the food is rotated along with the rotation of the crank handle and the handle is used to push the food onto the cutter.

A problem with this mechanism is that it is difficult to operate the device owing to the fact that it is necessary to simultaneously operate the push pedal and rotate the crank handle to rotate the food. Accordingly, it is difficult to achieve a consistent thickness of sliced food.

Food slicing devices differ greatly in the type of rotary traveling mechanism employed. The mechanism typically requires two motors, one for rotating the crank and one for driving the crank along the device. Food slicing devices are typically occupy a large volume and are expensive

In addition, it is necessary to return the rotary traveling mechanism to its initial position after slicing the food and this requirement demands a reverse rotation. Therefore, the whole rotary traveling mechanism should have an idle transition when it advances to cut the food and then return to its original position when the rotation is reversed.

The present invention aims to solve is to supply a food slicer driven by a motor to cut the food into even slices. The slicer drives the food to complete both the rotation and the traveling motions simultaneously, and is provided with an idle mechanism, which is in idle state after it rotates forward in position and realizes the backward movement of the screw rod after the reversing.

This invention adopts a technical proposal in order to solve the above technical matters, which is a food slicing device comprising a chassis and a fixed jaw to fix the food. The fixed jaw is driven forward or backward by the rotary traveling mechanism. The cutter is installed in the traveling direction of the rotary traveling mechanism, which is fixed to the chassis and driven by a motor and includes a screw rod and a screw rod rotary traveling mechanism; the fixed jaw is fixed to the front end of the screw rod and an idle mechanism is provided at the rear end of the screw rod where the screw rod rotary traveling mechanism drives the gear set by the motor. The gear set drives the screw rod to rotate. The screw rod passes through the cavity shell and at least part of the inner wall of the cavity is provided with the internal thread engaging with the thread of the screw rod.

Based on the above proposal, the specific gear set includes a motor gear driven by the motor as well as a rotary gear engaged with it. The rotary gear is set inside cavity. Both the central through-hole of the rotary gear and the cross-section of the screw rod are of the segmental shape; the cross-section of the screw rod is mated with the central through-hole of the rotary gear. The screw rod passes through the central through-hole of the rotary gear and rotates along with it.

The working principle of the rotary traveling mechanism in this invention is that, the motor drives the motor gear to rotate so that the rotary gear rotates along with the rotation of the motor gear by engaging the motor gear with the rotary gear. The rotary gear has a segmental central through-hole, which is mated with the cross-sectional shape of the threaded rod, therefore the threaded rod that penetrates the central through-hole of the rotary gear rotates along with the rotary gear and thus the rotary motion is completed. The threaded rod has threads on the surface and also is muff-coupled with the rotary gear. The internal thread engaged with the threaded rod is provided on inner wall of the threaded rod shell, therefore the backward and forward traveling motion can be fulfilled simultaneously along with the rotation of the threaded rod.

The fixed jaw is set in the front end of the rotary traveling mechanism in order to fix the food and prevent the uneven slicing caused by the shake during the rotary slicing. The fixed jaw includes the pedestal and the jaw overhanging the pedestal. The food is cut into the slices by the cutter;

In order to chain more sliced foods together, a plug hole capable of inserting a stick is provided on the pedestal for further cooking and processing. The food slices are fixed by the jaw after they are chained into the stick. Taking the potato as an example, after the potato is chained into the stick, back end of the stick is inserted into the plug hole of the fixed jaw for the fixation and the front end is provided with a supporting point to keep the stability. Then the food slicer is started to slice the potato with the cutter. The stick chained with the potato slices can be taken off after the cutting and be directly fried in an oil-bath for eating.

A cutter carrier is equipped in the traveling direction of the rotary traveling mechanism, on which the cutter is installed. Cutters with different structures can be adopted according to different requirements to realize the slicing, billet cutting, shredding, spiral cutting and peeling, etc.

In order to make the whole structure more compact and on the basis of the above arrangement, the shell cavity is of the staircase structure, which includes cavities of both big inner diameter and small inner diameter connected with each other. A rotary gear is provided in the large cavity and the internal thread is provided on the inner wall of the small one.

The rotary gear has the teeth in the middle engaged with the motor rotary gear to strengthen the structure. Both sides of the rotary gear are fixed in the large cavity via the bearing.

A bracket is extended below the shell to support and fix the motor. The shell has a gap cut in the extended direction of the bracket and at least part of the motor gear protrudes into the shell through the gap to engage with the rotary gear. The shell is formed integrally with the bracket, which is connected with the side edge of the shell end face, presenting a substantially “7” shaped structure. The end face corresponds to the large cavity and the gap is provided at the lower part.

The rotary gear, the shell cavity and the threaded rod are placed coaxially, which realizes the synchronization of rotation and traveling of the threaded rod.

An axle hole is provided on the bracket. The motor is fixed on the outer side of the bracket and the motor shaft is connected with the motor gear by passing through the axle hole. The central through-hole of the motor gear is of a segmental shape and the cross section of the motor shaft is of the same shape mated with the through-hole. The motor drives the motor gear to rotate.

No thread is provided on the segmental tangent plane of the screw rod. The screw rod includes the thread part and the threadless head. The diameter of the head is less than that of the thread part; the head is connected with the idle mechanism.

The rotary mechanism is composed of the return head, the stop structure of the return head and the spring mechanism. Head of the screw rod is connected with the spring mechanism by a connecting rod fixed to the spring mechanism. Middle of the return head is provided with a through-hole. The connecting rod passes through the through-hole with one end neighboring to head of the screw rod and the other end resisting against the spring mechanism. The stop structure is set in the travel direction of the return head to prevent the return head from advancing along with the screw rod. When the return head reaches the stop position and the spring mechanism has not been compressed, the thread part of the screw rod remains being engaged with the internal thread of shell, therefore the spring mechanism is gradually compressed. When the spring mechanism is fully or partly compressed, the thread part of the screw rod will be disengaged with the internal thread of the shell and the screw rod slacks.

The screw rod is rotated positively (namely, clockwise) or negatively (namely, anticlockwise) by the motor. When the screw rod rotates positively and forward, the spring mechanism goes forward with the screw rod owing to the fixed connection of the spring mechanism with the screw rod via the connecting rod. However, after a certain forward distance, the return head is limited by the stop structure while the spring keeps on going forward, thus the spring mechanism is gradually compressed.

When the screw rod advances in position, thread of the screw rod is disengaged with the internal thread of the shell owing that no thread is provided in head of the screw rod, therefore the screw rod is in idle state driven by the motor;

When the motor drives the screw rod to rotate negatively, the thread part of the screw rod will not enter into the shell to engage with the inner thread automatically owing to the disengagement of the threads. While under the double action of both the elastic-restoring force of the spring mechanism and the negative rotation of the screw rod, the threads are engaged with each other and the screw rod begins to rotate backward, finally the three steps of forward rotation, idle stall and backward rotation are realized.

The stop structure refers to the shell or the stop block set between the shell and the return head.

The spring mechanism includes the spring seat fixed with the connecting rod, the spring and the spring pressure plate. The spring fits over the connecting rod with one end resisting against the pedestal of spring seat and the other end resisting against the spring pressure plate. The spring pressure plate has a through-hole in the middle, from which the plate fits over the connecting rod with one end resisting against the spring and the other end contacting with the return head. The spring seat includes the pedestal. A connecting rod is vertically fixed in middle of the pedestal and is fixing-connected with head of the screw rod after the spring, the spring pressure plate and the return head are pulled through the connecting rod in turn. In detail, the connecting rod is muff-coupled with the spring, and passes through the through-holes of both the spring pressure plate and the return head, and then is fixing-connected with end of the screw rod.

An inner screw hole is provided at head of the screw rod and the external thread is provided in the front end of the connecting rod. The connecting rod is threaded with the head of the screw rod. Other connecting methods can be adopted such as the riveting and the screw fastening, etc.

The spring seat rotates along with the screw rod owing to the fixed joint between the screw rod and the spring seat; the shell is fixed deadly and the return head is in the compressed state along with the spring mechanism. Furthermore, when the shell serves as the stop structure of the return head, it is also in the compressed state, thus the rotating friction will be generated during the rotation process, or it even can cause the screw rod incapable of being driven. Therefore the rolling contact surface is provided on the surface of the return head contacting with the spring pressure plate. One or more locating holes are provided in the surface of the return head contacting with the spring pressure plate and the steel balls are put in the locating hole; Corresponding beading is provided on the spring pressure plate for the rolling of the steel ball so that the spring pressure plate can rotate freely betaking the connecting rod as the axes.

In order to further reduce the friction between the spring pressure plate and the return head, this invention adopts the ball sliding structure. That is, the locating holes on the return head adopts the loop arrangement and the beading on the spring pressure plate adopts the corresponding loop beading.

In order to better fix the spring, both the spring pressure plate and the spring seat pedestal are provided with the noses. Two noses are set face to face and the spring fits over them for positioning.

In order to keep the entire appearance, the spring seat pedestal adopts the shell structure. A cavity is formed between the spring pressure plate and the spring seat; the spring pressure plate and the spring are placed in the cavity and at least part of the return head can extend into the cavity structure.

On basis of the proposal mentioned above, the food slicing device is provided with the forward and backward travel switches in order to fulfill the forward, idle and backward processes automatically. When the rotary traveling mechanism and the idle mechanism advance in position, the travel switch controls the motor to stall and then reverse; when the rotary traveling mechanism and the idle mechanism go backward in position, the travel switch controls the motor to stop.

Embodiments of the present invention will now be described by way of example only and with reference to the accompanying drawings, in which

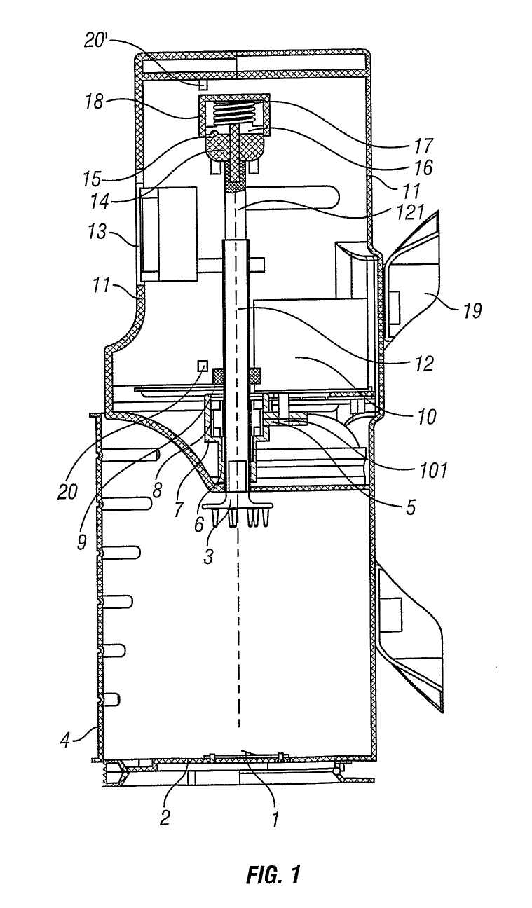

FIG. 1 is a sectional of the food slicing device according to an embodiment of the present invention, in a first configuration;

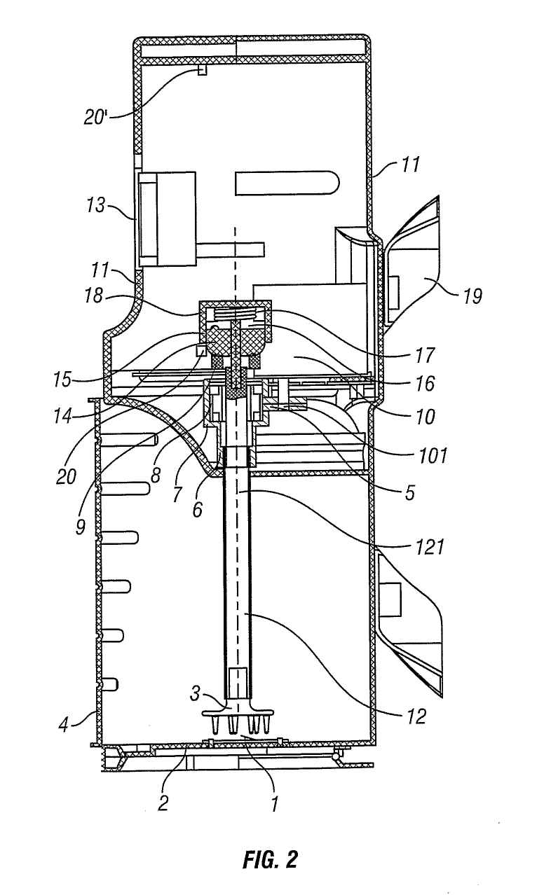

FIG. 2 is a sectional view of the food slicing device of FIG. 1 in a second configuration;

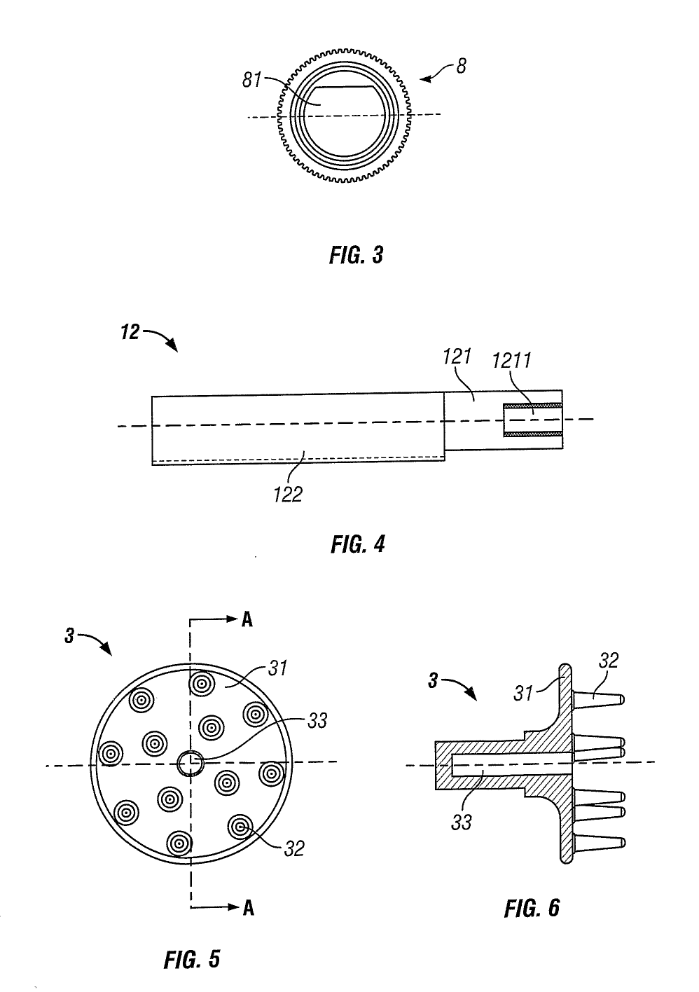

FIG. 3 is a side view of the rotary gear;

FIG. 4 is a sectional view of the screw rod

FIG. 5 is a front view of the fixed jaw;

FIG. 6 is a sectional view along line A-A of the fixed jaw of FIG. 5

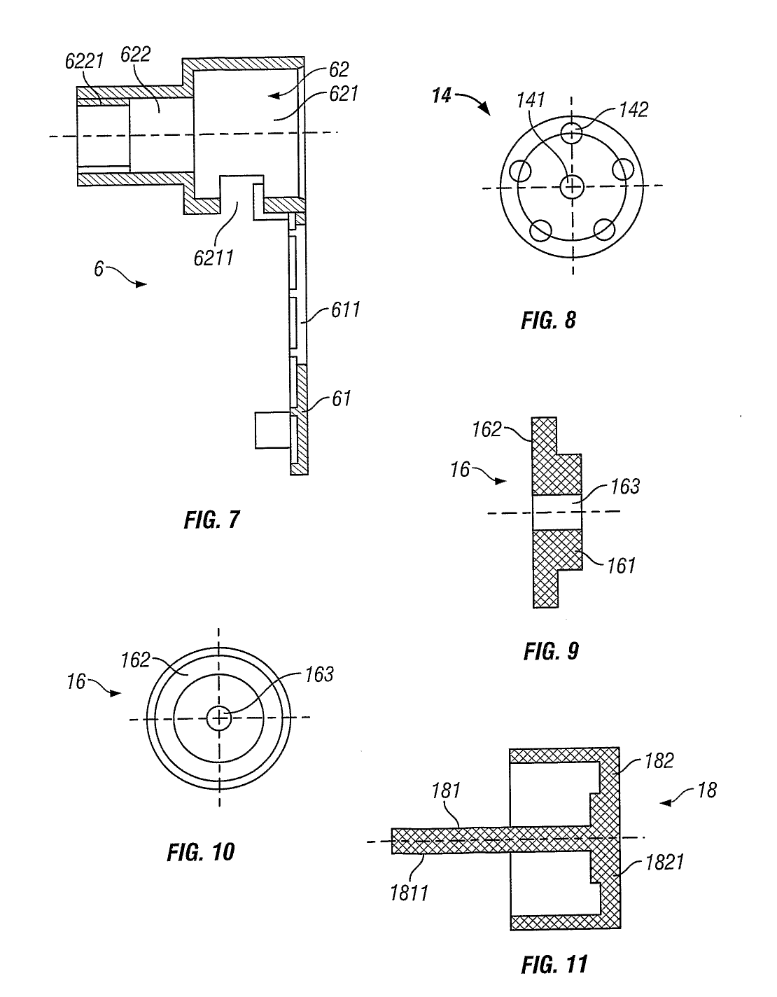

FIG. 7 is a sectional view of the shell;

FIG. 8 is a side view of return head;

FIG. 9 is a sectional view of the spring pressure plate;

FIG. 10 is a front view of spring pressure plate of FIG. 9; and,

FIG. 11 is a sectional view of the spring seat.

Referring to FIGS. 1 and 2 of the drawings, there is shown a food slicing device according to an embodiment of the present invention. The slicing device comprises a chassis 11 and a fixed jaw 3 to fix the food to be sliced. The fixed jaw 3 is driven by the rotary traveling mechanism to move forward or backward. A cutter carrier 2 is installed in the travel direction of the rotary traveling mechanism, on which the cutter 1 is installed. The rotary traveling mechanism is fixed on the chassis 11 and is driven by a motor 10, which includes a screw rod 12 and a screw rod rotary traveling mechanism. The fixed jaw 3 is fixed in the front end of the screw rod 12 and an idle mechanism is provided at the rear end of the screw rod 12, in which the screw rod rotary traveling mechanism drives a gear set with the motor 10. The gear set drives the screw rod 12 to rotate. The screw rod 12 passes through a shell 6 with the cavity 62 and at least part of the inner wall in the cavity is provided with an internal thread 6221, which is engaged with threads of the screw rod 12.

Referring to FIGS. 3 and 4 of the drawings, the gear set includes the gear 5 driven by motor 10 and a rotary gear 8 engaged with the gear 5. The rotary gear 8 is set inside the cavity 62 of the shell 6 and the center hole 81 of the rotary gear 8 is of the segmental shape. The cross-section of the screw rod 12 is of the segmental shape and is mated with a center hole 81 of the rotary gear. The screw rod 12 passes through the central through-hole 81 of the rotary gear 8 and rotates along with it. The segmental tangent plane of the screw rod 12 has no thread; the screw rod 12 includes the thread part 122 and a threadless head 121 The head 121 is smaller than the thread part 122 in diameter; the head 121 has an inner bolt hole 1211 connecting with the idle mechanism.

Teeth engaged with the motor gear 5 are provided in the middle of the rotary gear 8; both sides of the rotary gear 8 are fixed to the large cavity 621 of the shell 6 by a bearing 7.

Referring to FIGS. 5 and 6 of the drawings the fixed jaw 3 includes the pedestal 31 and a jaw 32 overhanging the pedestal 31. The plughole 33 is provided on the pedestal 31 for inserting a stick and the food is chained in the stick and fixed by the jaw 32.

Referring to FIG. 7 of the drawings, the cavity 62 of the shell 6 is of the staircase structure, which includes a large cavity 621 and a small cavity 622. The rotary gear 8 is provided in the large bore cavity 621 and the internal thread 6221 is provided on the inner wall of the small one 622. A bracket 61 is extended below the shell 6 to support and fix the motor 10; the tap 6211 is made in the extending direction of the bracket 61 of the shell 6. At least part of the motor gear protrudes into the shell 6 from the gap 6211 and is engaged with the rotary gear 8. The axle hole 611 is provided on the bracket 61 and the motor 10 is fixed in outer side of the bracket 61. A motor shaft 101 passes through the axle hole 611 to connect with the motor gear 5.

Referring to FIG. 8 of the drawings the idle mechanism is composed of the return head 14, the stop structure of the return head and the spring mechanism. Head 121 of the screw rod is connected with the spring mechanism by a connecting rod fixed to the spring mechanism 181, in which middle of a return head 14 is provided with a through-hole 141. The connecting rod 181 passes through the through-hole 141 with one end neighboring to head 121 of the screw rod 12 and the other end resisting against the spring mechanism. The stop structure is the shell 6 or a stop block 9 provided between the shell 6 and the return head 14. When the return head 12 reaches the stop position and the spring mechanism has not been compressed, the thread part 122 of the screw rod 12 remains being engaged with internal thread 6221 of the shell 6. When the spring mechanism is compressed, the thread part 122 of the screw rod 12 is disengaged with the internal thread 6221 of the shell 6 and the screw rod 12 slacks.

Referring to FIGS. 9 to 11 of the drawings, the spring mechanism includes the spring seat 18 fixed with the connecting rod 181, the spring 17 and the spring pressure plate 16. The spring 17 is fitted over the connecting rod 181 with one end resisting against the spring seat pedestal 182 and the other end against the spring pressure plate 16. The spring pressure plate 16 has a through-hole 163 in the middle and the spring pressure plate 16 is fitted over the connecting rod 181 from the through-hole 163 with one end resisting against the spring 17 and the other in contact with the return head 14. The spring seat 18 includes the pedestal 182. A connecting rod 181 is vertically set in middle of the pedestal 182. The external thread 1811 of the connecting rod 181 head is fixing-connected with the inner bolt hole 1211 thread of the screw rod head 121 after the spring 17, the spring pressure plate 16 and the return head 14 are pulled through the connecting rod in turn. The spring seat pedestal 182 is of the cover structure and a cavity is formed between the spring pressure plate 16 and the spring seat 18. The spring 17 is put in the cavity and at least part of the Return Head 14 can extend into the cavity structure.

Five locating holes 142 are provided on the surface of the return head 14 contacting with the spring pressure plate 16 and the steel balls are placed into the locating hole 142; corresponding loop beading 162 is provided on the spring pressure plate 16 for the rolling of the steel ball 15 so that the spring pressure plate 16 can rotate freely by taking the connecting rod 181 as the axes.

Both the spring pressure plate 16 and the spring seat pedestal 182 are provided with noses 161 and 1821. Two noses 161 and 1821 are set face to face and the Spring 17 is fitted over them for positioning.

The food slicing device is provided with both the front and the rear travel switches 20 and 20′. The front travel switch 20 is set at the rear part of the stop block 9. When the rotary travel mechanism and the idle mechanism move forward in position, the front travel switch 20 will be triggered. Travel switch 20 controls the motor to pause for 3˜10 seconds and then reverse. The rear travel switch 20′ is set at the rear part of the spring seat 18 of the idle mechanism. When the rotary traveling mechanism and the idle mechanism move backward in position, the rear travel switch is triggered and then controls the motor 10 to stop.

Chassis 11 of the food slicing device according to an embodiment of this invention is placed on the sub-frame 19. A transparent protective cover is provided on the front top of the chassis 11 and an operation panel 13 is provided on the rear top used to manually control the operation of the food slicing device.

1-26. (canceled)

27. A food-slicing device comprising:
holding means for holding the food to be sliced;
conveyance means configured to:
convey the food to be sliced in a conveyance direction along the device; and
rotate, simultaneously, the means for holding the food substantially about an axis of rotation comprising the conveyance direction, and
a cutter positioned substantially within the conveyance direction, the cutter configured to cut the food at one side of the axis of rotation as the food is conveyed along the conveyance direction and as the food rotates about the axis of rotation, wherein said configuration produces a substantially helical food shape.

28. The food-slicing device according to claim 27, wherein the conveyance means comprises a drive shaft, the drive shaft comprising a threaded section.

29. The food-slicing device according to claim 28, wherein the conveyance means further comprises a motor for driving the drive shaft.

30. The food-slicing device according to claim 29, wherein the motor is configured to drive the drive shaft in a first conveyance direction and a second conveyance direction.

31. The food-slicing device according to claim 30, wherein the first conveyance direction and the second conveyance direction are substantially opposite directions.

32. The food-slicing device according to claim 30, further comprising at least one switch for switching the conveyance direction between the first and second conveyance direction.

33. The food-slicing device according to claim 28, wherein the drive shaft is coupled to the holding means.

34. The food-slicing device according to claim 27, wherein the holding means comprises at least two spikes for impaling the food to be sliced.

35. The food-slicing device according to claim 27, further comprising a gear arrangement configured to selectively control a rotational speed of the holding means for holding the food.

36. The food-slicing device according to claim 27, wherein the cutter is orientated at an angle to axis of rotation.

37. The food-slicing device according to claim 36, wherein the angle is variable to selectively control thickness of the food shape.
